(19) United States
(12) Patent Application Publication
(10) Pub. No.: US 2014/0157108 A1
(43) Pub. Date: Jun. 5, 2014

(54) LIVE-UPDATING WEB PAGE GENERATION

(71) Applicant: METEOR DEVELOPMENT GROUP, INC., San Francisco, CA (US)

(72) Inventors: Geoffrey Robert Schmidt, San Francisco, CA (US); Nick Martin, Berkeley, CA (US); Matthew DeBergalis, San Francisco, CA (US); David L. Greenspan, Oakland, CA (US)

(73) Assignee: METEOR DEVELOPMENT GROUP, INC., San Francisco, CA (US)

(21) Appl. No.: 13/691,732

(22) Filed: Nov. 30, 2012

(51) Int. Cl. G06F 17/22

(52) U.S. Cl. CPC G06F 17/2247
USPC 715/234

(57) ABSTRACT

Embodiments disclosed herein may relate to generating an application with live updating web page for display on a user computing platform.

### BACKGROUND

### Field

Subject matter disclosed herein may relate to generating an application with live updating web page for display on a user computing platform.

### INFORMATION

The success of World Wide Web (Web) based applications continues to change the way the Internet in general, and the Web in particular, is utilized. Rather than being merely a convenient way to publish information, web pages may be transformed into Web-based computing platforms. Compared with desktop applications, online systems may bring benefits such as, for example, universal accessibility and the ability to readily share and cooperate with others. However, development of online applications may typically involve a programmer solving many issues and problems that may arise due to difficulties in tracking data dependency issues, for example.

For example, a programmer may need to write code to track changes to various data dependencies within an application. Such dependencies may be extremely complex in many situations. Additionally, maintenance of online applications with data dependencies may be problematic because the programmer may update an online application template to incorporate a new or changing data source and may forget to update any associated logic that may monitor the dependencies of a page, for example. Also, for a typical online application, once it has been detected that a page needs to be updated, the entire online application template for a web page may be re-rendered. Such an update may be extremely inefficient due to updating an entire online application web page rather than just the portion of the page that includes the new or updated data, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a diagram illustrating an example system for generating and/or updating a web page for an online application in accordance with an embodiment.

FIG. 2 is a diagram illustrating an example system for generating and/or updating a web page for an online application in accordance with an embodiment.

FIG. 3 is an illustration depicting an example online application template in accordance with an embodiment.

FIG. 4 is a flow diagram illustrating an example process for generating and/or updating a web page for an online application in accordance with an embodiment.

FIG. 5 is a block diagram illustrating an example system comprising a plurality of computing devices coupled via a network in accordance with one or more embodiments.

Reference is made in the following detailed description to the accompanying drawings, which form a part hereof, wherein like numerals may designate like parts throughout to indicate corresponding and/or analogous elements. It will be appreciated that elements illustrated in the figures have not necessarily been drawn to scale, such as for simplicity and/or clarity of illustration. For example, dimensions of some elements may be exaggerated relative to other elements for clarity. Further, it is to be understood that other embodiments may be utilized. Furthermore, structural and/or logical changes may be made without departing from the scope of claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit the scope of claimed subject matter and/or equivalents.

### DETAILED DESCRIPTION

In an embodiment, the Internet may comprise a worldwide system of computing platforms and computer networks and may further comprise a public, self-sustaining facility that may be accessible to tens of millions of people worldwide. Also, in an embodiment, a widely used part of the Internet may comprise the World Wide Web, often abbreviated “WWW” or simply referred to as just “the web”. The web may comprise an Internet service that organizes information through the use of hypermedia. A HyperText Markup Language (“HTML”) may be utilized to specify contents and format of a hypermedia document, such as a web page. An Extensible Markup Language (XML) may also be utilized to specify contents and format of a web page, in an embodiment. However, HTML and XML are merely example markup languages, and claimed subject matter is not limited in these respects.

As used herein, a “web site” may refer to a collection of related web pages, in an embodiment. Also as used herein, “web page” may relate to any electronic document that may be accessed via a network, such as the web, in an embodiment. As alluded to above, in one or more embodiments, a web page may comprise a document coded using one or more markup languages, such as, for example, HTML and/or XML, although claimed subject matter is not limited in scope in this respect. Also, in one or more embodiments, online application developers may write code in JavaScript, for example, to provide data to populate one or more templates for an online application. However, JavaScript is merely an example programming language, and claimed subject matter is not limited in these respects.

As mentioned above, development of web-based applications may typically involve a programmer solving many issues and problems that may arise due to difficulties in tracking data dependency issues, for example. A programmer may need to write code to track changes to various data dependencies within an application, for example, and such dependencies may be extremely complex in many situations. Additionally, maintenance of web applications with data dependencies may be problematic because the programmer may update an online application template to incorporate a new or changing data source and may forget to update any associated logic that may monitor data dependencies, for example. Also, for a typical online application, once it has been detected that a web page needs to be updated, an entire template for the web page may be re-rendered. Such an update may be extremely inefficient due to updating an entire page rather than just the portion of the page that includes the new or updated data, for example.

In typical practice for conventional online application development, a template may be executed once at a particular point in time, thereby producing an HTML string, for example, that may reflect a state of the application at that particular point in time. A state of an online application may reflect return values of JavaScript code, for example, that may provide values for variables defined in a template, and also may reflect current values of data fields referenced in a template. An HTML string reflecting a state of an online application may be parsed into a tree of its constituent elements by a web browser executed on an end-user computing device, for example, and displayed on a display screen.

Also, for conventional online application development practice, if it was desired to have a web page that updates itself without having to be reloaded, that is, if it was desired to have a web page with live update, obstacles may be encountered by an online application developer. For example, a programmer may have to detect a condition that data on an online application web page was stale and in need to be redrawn. In a conventional online application, a stale data condition may be detected by an out-of-band mechanism, in some circumstances. It may be complicated to detect a stale data condition, for example, because a web page may include data from a variety of different backend services or from a large number of individual database objects and fields. A programmer may need to write code to track changes to some or all of these dependencies. Code to track changes to data dependencies may be regarded as wasteful because information regarding data dependencies for a web page may already be implicitly contained in a specification of a template for an online application and its associated JavaScript code.

Further, prior online application systems may require that data dependencies be explicitly declared, or require helper code associated with a template to either return data values directly or to supply wrapped dynamic value objects with which a template system may register for updates. Typically, custom code may be written by online application developers to track data change events, and in response to a data change event, locate a template and perform a custom update or patch to the template to account for the data change event.

In an embodiment in accordance with claimed subject matter, an online application system may include techniques for inferring data dependencies from template definitions, such as template definitions typically produced by online application developers. Data dependencies may be inferred at run-time by rendering the template and discovering which data sources the template uses. An online application developer's code, in an embodiment, would not need to be modified to allow automatic data source tracking.

Additionally, in an embodiment implementing automatic data source tracking for online applications, including techniques for inferring data dependencies from template definitions, live-updating web sites may be much more readily created and maintained. For example, live-updating web sites may be just as easily developed as conventional web pages. In an embodiment, an online application developer may write HTML code, for example, just as they normally would for non-live updating web sites, and an example embodiment of an automatic data source tracking system may keep the web page automatically up to date as any underlying data for the web site changes.

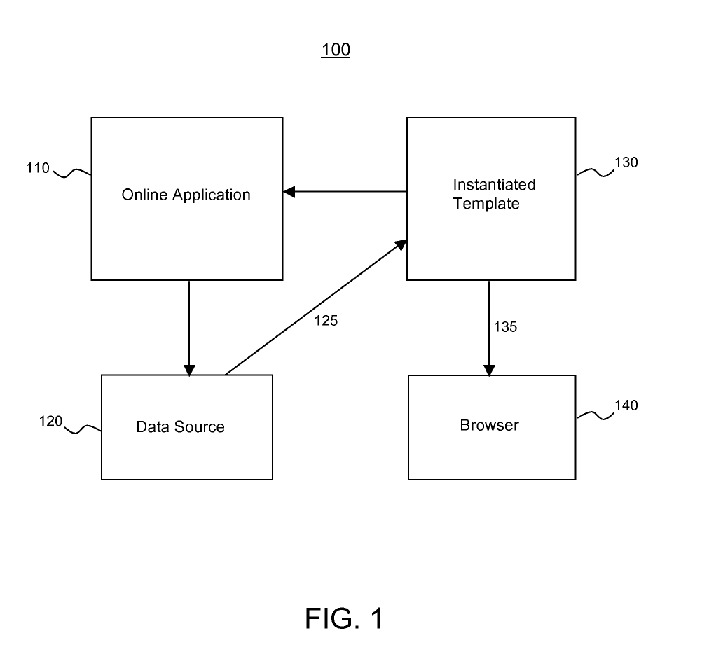

FIG. 1 is a diagram illustrating an example system 100 for generating and/or updating a web page for an online application in accordance with an embodiment. Online application 110, in an embodiment, may represent any type of online application. Example online applications may include, for example, banking applications or social networking sites, although any of a wide range of online application types are possible. Specific online applications discussed herein are merely examples, and claimed subject matter is not limited in this respect.

In an embodiment, online application 110 may comprise one or more templates. Individual templates may contain a specification of template contents, and may also include online application developer's programming code to supply data to a template.

In an embodiment, an online application developer may write an HTML template for a web page of the online application in a typical fashion. For example, in a situation where a template includes dynamic content, a developer may insert templating directives. In an embodiment, templating directives may be expressed in a popular “Handlebars” templating syntax, although claimed subject matter is not limited in this respect. For an example, a syntax {{firstName}} may indicate that a value of “firstName” should be inserted at a particular point in the template, where “firstName” comprises a value that may either come from a database record or may otherwise be defined in a software program that may accompany a template.

Additionally, a syntax {{#if condition}} . . . {{/if}} may indicate a block of HTML code that should be included in response to “condition” being true, wherein “condition”, like “firstName”, may comprise a named value that comes from outside a template, in an embodiment.

In an embodiment, a syntax {{#each people}} . . . {{{/each}} may indicate a block of HTML code that should be repeated for individual records in the set of records called “people”, for example, which again may be defined outside a template and may represent a database query. Additional “Handlebar” constructs may also be supported in one or more embodiments, although claimed subject matter is not limited in these respects.

In an embodiment, a template for a high score list in an online application game might look like this, although claimed subject matter is not so limited:

```
<div class=“count”>Number of players: {{playerCount}}</div>
<div class=“scoreboard”>
{{#each players}}
  <div class=“player”>
    <div class=“name”>Player name: {{name}}</div>
    <div class=“score”>Score: {{score}}</div>
  </div>
{{each}}
</div>
```

Also, in an embodiment, a set of definitions for individual variables in a template, for example playerCount, players, name, and score, in the example above, may be provided in a programming language such as JavaScript. In an embodiment, a templating engine may call out to code, such as JavaScript code, for example, to retrieve values to populate a template.

Continuing with the example “Handlebars” and JavaScript-based embodiment discussed above, template variables may receive their value in one of a various ways. For example, template variables may comprise what may be referred to as “helpers”. Individual helpers may be associated with JavaScript code that programmatically may provide a value of a respective individual variable. In an embodiment, a helper may comprise a JavaScript procedure that if executed may return a value to be used for a variable at a particular point in time, or it may comprise a JavaScript expression that provides a final value for a variable.

In an embodiment, a name of a variable may be interpreted to comprise a “data field” in response to not matching any defined helper, for example. A data field may refer to an attribute of a “current object” in a template. For example, inside an {{#each}} block, a “current object” may comprise an object being referenced by a particular repetition of a block. Referring to the scoreboard example mentioned above, {{name}} may comprise an example of a “data field”, referring to the “name” attribute of a different player object in a database in individual repetitions of the {{#each}} block. In response to multiple {{#each}} blocks being nested, a current object may be determined by the innermost enclosing {{#each}} block, for example, although claimed subject matter is not limited in scope in this respect.

JavaScript code that may accompany an example template, such as the template listed above may comprise the following, for an example embodiment (assuming that the template is named “scores”):

```
Template.scores.playercount = function () {
  // Find all of the Player objects in the database and return how many
  // there are.
  return Players.find().count();
};
Template.scores.players = function () {
  // Return a database cursor referencing all of the Player objects in the
  // database.
  return Players.find();
};
Template.scores.score = function 0 {
  // The “current object” (a player) is in “this”. Compute the player's
  score. // In this game, a player gets 10 points for a win and loses 5
  points for // each loss.
  return this.wins * 10 - this.losses * 5;
};
// “name” need not be defined because it defaults to being the “name”
attribute // on the current player.
```

Further, in an embodiment, example system 100 may include one or more data sources 120. In an embodiment, data source 120 may comprise a reactive data source that may provide data to online application 110 and may also provide data dependency information 125 to a dependency tracking component of an instantiated template 130, for example. In an embodiment, an instantiated template may comprise a template that has been previously rendered.

Also, in an example embodiment, instantiated template 130 may comprise a re-rendering component that may utilize data dependency information 125 to re-render online application 110. Instantiated template 130 may provide updated instructions 135 to a browser application 140 executed on an end-user computing device. In this manner, an online application being executed by browser 140 may receive updated instructions to update any changing data without needing to re-render an entire web-page.

In an embodiment, one or more templates may be rendered within a browser, such as browser 140, executed on an end-user computing device, for example. Also, in an embodiment, as a template is rendered by the browser, calls may be made to associated JavaScript functions to retrieve data needed to populate the one or more templates. As mentioned previously, although example embodiments described herein mention JavaScript, claimed subject matter is not limited in this respect.

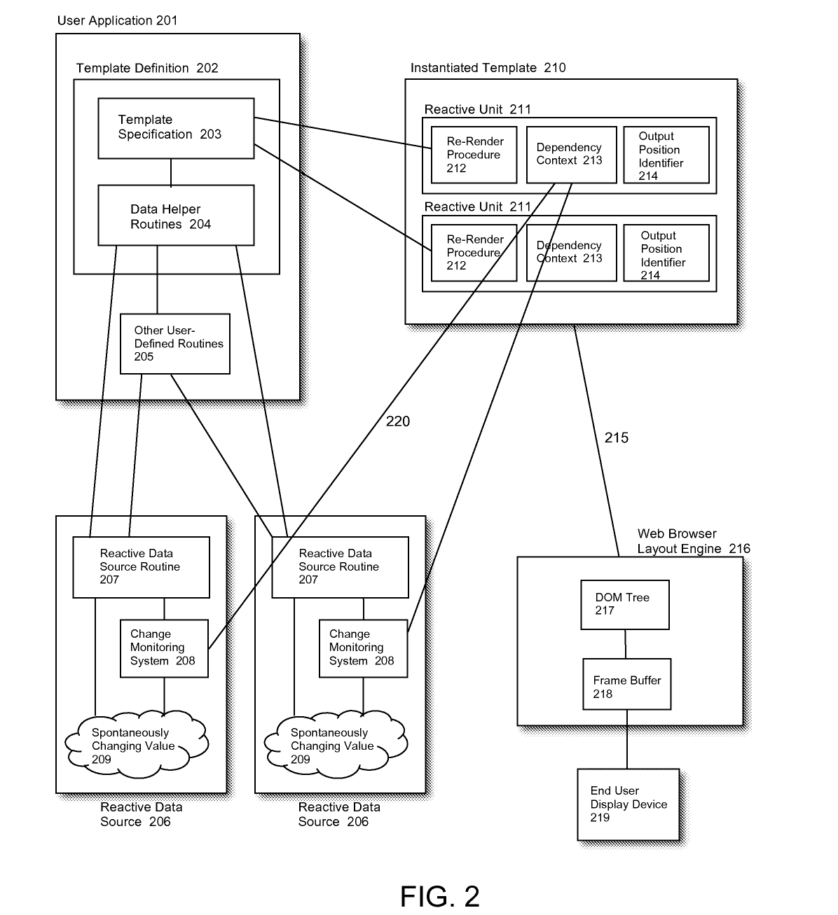

FIG. 2 is a diagram illustrating an example system 200 for generating and/or updating a web page for an online application in accordance with an embodiment. FIG. 2 may comprise a system similar to that discussed above in connection with FIG. 1. However, example system 200 of FIG. 2 may provide additional detail.

For the example system 200 depicted in FIG. 2, user application 201 may represent an online application, for example a banking application or a social network site, although claimed subject matter is not limited in this respect. One or more embodiments may include online applications that may comprise custom reactive data sources, such as reactive data sources 206. Additionally, in an embodiment, an online application 201 may include one or more template definitions 202. Individual template definitions may contain a specification 203 of template contents. In an embodiment, a “Handlebars” syntax may be utilized as well as one or more developer-written code routines, such as data helper routine 204, although claimed subject matter is not limited in scope in these respects. In this manner, template specification 203 may include references to code routines to call to retrieve inputs for a template 202.

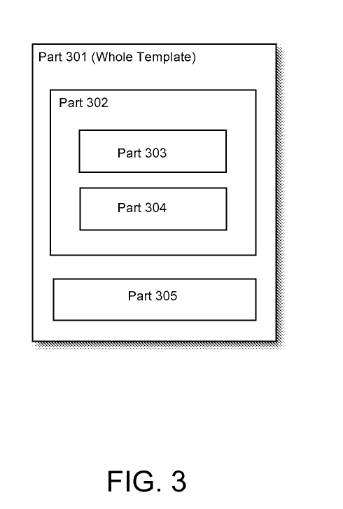

In an example embodiment, individual templates may be divided into one or more parts which may be update independently. For example, if data dependencies for one part of a template changes, other parts of the template may not be affected, and only the part of the template that is affect may be re-rendered rather than re-rendering the entire template. In one or more embodiment, a nested tree structure may be utilized. Typically it is most natural to structure the parts as a nested tree. See FIG. 3 for an example nested tree structure in accordance with an embodiment.

Data helper routine 204 may be shared among one or more template specifications 203, in an embodiment. Similarly, because there are often common elements between template specifications, for example a “like” button or calendar date picker widget, that may appear at a plurality of places on a website, template specifications may be advantageously organized as a combination of reusable sub-template components, or parts. See FIG. 3 for an example tree structure for a template wherein a template 301 may comprise a plurality of nested parts.

In an embodiment, data helper routines 204 may call other functions, which may call other functions, and so on, in an arbitrarily deep chain. For example, those functions might be part of a library of other user-defined routines 205 in user application 201 that may be used both by template code and by other functions in the application, in an embodiment.

As mentioned, an online application may access one or more reactive data sources 206. In an embodiment, reactive data source 206 may comprise reusable components utilized alongside an application. However, some online applications may define their own reactive data sources. In an embodiment, data helper routines 204 may present like an ordinary function, such as reactive data source routine 207, that returns a value in response to being called. Example values that may be returned may include, for example, a current time (accurate to the nearest second), an amount of records in a database that match specified criteria, and/or a width of a user's browser window. However, these are merely example types of data values, and the scope of claimed subject matter is not limited in these respects.

In an embodiment, reactive data source routine 207 may read a current value of an external data source, such as spontaneously changing value 209, for example. Examples of spontaneously changing data may include records in a database that may be changed by a user, a width of a browser window that may change as a user resizes the window, or a constantly changing current time, which may represent a current time to the nearest second. Of course, claimed subject matter is not limited in scope to these particular example data types and/or values.

At least in part in response to being called by user application 201, reactive data source routine 207 may check to see if it is running in a dependency context. A check may be performed by checking a value of a global variable which may be thought of as a dynamically scoped value. If a check determines that routine 207 is not running in a dependency context, for example if it was called from a part of the program that has no interest in tracking changes to reactive data sources, routine 207 may retrieve a current value of spontaneously changing value 209 and return it to the caller. If, however, a check determines that dependency tracking is desired, routine 207 may retrieve a current value of spontaneously changing value 209 and return it to the caller, and change monitoring system 208 may monitor future changes to spontaneously changing value 209. For example, if spontaneously changing value 209 comprises a value from a database, changes may be monitored by establishing a listener on a message bus for notifications of changes to the database. For an example embodiment wherein spontaneously changing value 209 comprises a width of a browser window, monitoring may be accomplished, for example, by registering a callback with a web browser. If value 209 comprises a current time, monitoring may comprise receiving input from a periodic timer. Of course, these are merely example techniques for monitoring spontaneously changing values, and claimed subject matter is not limited in scope in these respects. A link 220 may be established between change monitoring system 208 and a dependency context 213 in which reactive data source routine 207 is executed.

Instantiated template 210 depicts an example particular instantiation of template definition 202 for an example embodiment. In an embodiment, instantiated template 210 may represent content on an end user's screen to be kept up to date. Also, in an embodiment, template definition 202 may have zero, one or arbitrarily many instantiations at any given point in time.

In an embodiment, instantiated template 210 may be organized as a series of one or more reactive units 211, for example. In an embodiment, there may be a one to one relationship between parts of a template such as those depicted in FIG. 3 and reactive units 211 in an instantiation of a template, such as instantiation 210. In response to a template being initially instantiated, as individual parts are rendered, a re-render procedure 212 may be created, wherein the re-render procedure 212 contains enough information to re-render a particular part. For example, re-render procedure 212 may call into a templating system and may request rendering to be performed over a region of a template spanned by that part, and the result returned. Also, for individual parts, a new and separate dependency context 213 may be created. In response to a part being rendered, dependency context 213 may accumulate links 220 to reactive data sources 206 used by that part. In an embodiment, corresponding change monitoring system 208 may cause that only parts with changed values are redrawn in response to a detection of a change to spontaneously changing value 209.

Additionally, at least in part in response to a rendering of individual parts of a template, an identifier, such as output position 214, may be created that may be utilized to locate an individual part at a later time, such as after an individual part has been loaded into a web browser, for example, and shown on an end-user's screen, such as end-user display device 219. Output position identifier 214 may comprise sufficient information so that Document Object Model (DOM) nodes within DOM tree 217 corresponding to the particular part may be located and replaced when the time comes to update the part in response to a change in a value 209.

Particular techniques for generating output position identifier 214 may depend at least in part on a particular architecture for online application 201. For example, in an embodiment, as individual parts are rendered, a large pseudorandom number may be computed, and the large pseudorandom number may be placed in HTML comment nodes that may inserted before and after elements in a rendered part. In this example, output position identifier 214 may comprise a pseudorandom number generated for the individual part. In another embodiment, it may be ensured that first and last HTML nodes in a rendered part have identification attributes. For example, pseudorandom numbers may be generated to use as identifiers in response to the elements not already having identifiers, and pseudorandom numbers may be utilized as output position identifier 214, in an embodiment. Further, in an embodiment, in response to instantiated template 210 and a web browser layout engine 216 being executed within the same virtual machine, output position identifier may comprise a pair of pointers to a first and a last DOM element representing the individual part. In this situation, it may be beneficial to have individual parts have no other output position identifier have the same start and end position. This may be because such co-terminal rendered template parts may create problems on re-rendering. For example, if four different reactive units 211 all had an output position 214 that pointed to the same DOM node, then when any of those reactive units 211 are updated, it may be necessary to find any other output position identifiers 214 that survive the re-rendering and update their pointers to point to the new, re-rendered element. Additionally, in an embodiment, for a situation in which user application 201 and web browser layout engine 216 are executed on separate computing platforms, a pseudorandom number may be utilized as an output position identifier 214 that may be paired with an indication of which connected web browser to send the message. For a hypothetical example, if 1 million people are connected to an online application, an output position identifier 214 may comprise “instantiated part number #123456789, on connected web browser client #43”, wherein #123456789 may comprise a pseudorandom number. Of course, claimed subject matter is not limited in scope to the specific examples described herein.

Further, in an embodiment, at least in part in response to a template being instantiated, results of rendering for individual parts may be combined to generate a tree 217 of DOM nodes comprising parsed HTML elements that are to be initially displayed to an end-user. DOM tree 217 may initially comprise a snapshot of a current state of spontaneously changing value 209 at a point in time when the template was instantiated. In an embodiment, web browser layout engine 216 may generate display pixels from DOM nodes with an addition of other resources such as image files and Cascading Style Sheets (CSS) styling directives, for example. Pixel information may be stored in a frame buffer 218, for example, and pixels may be displayed on an end user display device 219.

In an embodiment, in response to a change in a value 209, monitoring system 208 may detect that change and may signal the change through link 220 to one or more dependency contexts 213 that may be associated with individual reactive units 211 that may correspond through output position identifier 214 to respective DOM nodes of DOM tree 217 that were previously derived from that particular spontaneously changing value 209. Link 220, for example, may indicate that appropriate DOM nodes of DOM tree 217 may need to be updated.

Individual reactive units 211 may respond to a signal through link 220 that value 209 has changed at least in part by running a re-render procedure 212 to get the new, updated version of its template part. By so doing, a previous dependency context 213 may be no longer needed and may be destroyed, and corresponding links 220 may also be destroyed. Additionally, in response to a signal through link 220 that value 209 has changed, a new dependency context 213 for the re-rendering may be created to account for situations in which a part may now have different dependencies due to a change detected for spontaneously changing value 209. In an embodiment in which template parts may be nested, re-rendering a part may cause reactive units 211 associated with its contained parts to be destroyed, thereby destroying corresponding dependency contexts 213 and corresponding links 220. Also, in an embodiment, dependency contexts 213 and corresponding links 220 may be recreated at least in part in response to a re-rendering of the part. In destroying and recreating dependency contexts and corresponding links 220 in response to a re-render of a part corresponding to reactive unit 211, for example, situations where a template may use a different set of parts depending on a value of change monitoring system 208 may be accounted for, such as in a situation wherein a value derived from change monitoring system 208 appears as the condition in an {{#if}} block.

Further, for individual reactive units 211 in an instantiated template 210 that was re-rendered at least in part in response to a change in a value derived from a change monitoring system 208, one or more update instructions 215 may be composed, wherein the updated instructions comprise a new rendering along with an output position identifier 214 that may describe where an updated part is to appear in onscreen DOM tree 217. Updated instructions 215 may be applied to DOM tree 217, resulting in a change on an end-user's screen, such as end-user display device 219.

At least in part in response to a change monitoring system 208 having no links to active dependency contexts 213, system 208 may stop operating in order to conserve resources. For example, message bus subscriptions may be terminated and callbacks may be deregistered, although claimed subject matter is not limited in scope to these particular examples.

Additionally, at least in part in response to instantiated template 210 no longer being needed, perhaps because corresponding DOM nodes within DOM tree 217 have been permanently removed, dependency contexts 213 and links 220 may be destroyed to conserve resources. A determination may be made as to whether instantiated template 210 is no longer needed at least in part by occasionally and/or periodically checking to see if the DOM nodes of DOM tree 217 corresponding to instantiated template 210 are found in the DOM document being rendered by web browser layout engine 216. If a determination is made that instantiated template 210 is not needed, instantiated template 210 may be destroyed, for example.

As mentioned previously, embodiments in accordance with claimed subject matter may comprise web browser layout engine 216 and user application 201. In one or more embodiments, engine 216 and user application 201 may be executed within the same computing platform. For example, web browser layout engine 216 and user application 201 may both be executed on a laptop computer, for example, or on a cellular telephone, for another example. In other embodiments, all or a portion of user application 201 may be executed on a server computing platform, for example, and web browser layout engine 216 may be executed on an end-user computing platform.

In addition to template helpers, such as data helper routines 204, a template definition 202 in an embodiment may contain one or more template lifecycle callbacks which may be utilized to allow custom code from an online application developer to run at various stages in an instantiation, re-render, and destroy process. Additionally, an instantiated template 210 may contain a block of user-defined information that may be made available to, and may be modified by, these callbacks for the convenience of the developer.

Example callbacks may include a callback that may be called in response to a first instantiation of a template but before its initial rendering is available in DOM tree 217. This may be used, for example, to set up user-defined information or to start other custom services or functionality that might be associated with a template 202, such as, for example, timers or animations, although claimed subject matter is not limited in scope in these respects.

Further, in an embodiment, example callback types may include a callback that may be called at least in part in response to the template being guaranteed to be present in DOM tree 217. In an embodiment, information may be passed to this callback that may allow it to find a location/extent of a rendered template in the DOM so that it can be manipulated directly, for example to read a state of an HTML form element.

Additionally, in an embodiment, example callback types may include a callback that may be called every time the template or a part of it is re-rendered, with similar semantics to the previous, which may be used to reinstate custom behaviors that might have been lost during the rendering or to update any pointers that other application code might be holding to rendered elements.

Example callback types may also include callbacks that are called once a template or a part of if it deemed to have been destroyed, for example when its reactive unit/dependency context is disposed of. Such callbacks may be used to clean up external/custom resources that may be associated with the rendered template, for example that may be set up by other callbacks.

When update instructions 215 are applied to DOM tree 217, it may be sometimes desirable to not simply replace the DOM elements outright, especially those that have not changed during a re-rendering process. (even other elements in the part, such as their siblings or children, might have changed.) An example may comprise HTML <input> elements, for example text input boxes. Re-rendering a text input element, even if it is replaced with an exact copy of itself and its current contents is preserved, may lose the current interactive state of the element. For example, keyboard focus and cursor position may be lost, and if the user was composing an international character (such as an accented character that may require several keystrokes to enter on a particular keyboard), then the international character composition process may be disrupted and the user may need to start over. This may destroy an illusion that a web page is seamlessly updating in place. Another example is CSS animations that may be disrupted in a re-rendering process. For example, the animation may restart from the beginning as a result of the re-rendering rather than continuing from its present state.

To solve this potential issue, instead of replacing the range of DOM tree 217 indicated by output position identifier 215 with a new rendering in 215, a “patch procedure” may be carried out. A potential goal of the patch procedure may be to carry out a sequence of operations that may cause the DOM to reflect the new rendering requested by 215, but without disturbing the elements in DOM tree 217 that are common between the old and new rendering and need not or should not change. In an embodiment, “without disturbing” may include (1) making sure that the same DOM node objects are reused, rather than the old DOM node object and a new one recreated; (2) ensuring that the DOM node objects are not removed from the DOM document even if they are subsequently reinserted; (3) ensuring that the DOM node objects are not even re-parented to be the child of a different DOM node object without leaving the document.

An example patch procedure may comprise: 1) Identifying a set of pairs (A,B) of DOM nodes and/or HTML elements, where A may comprise a node/element in the requested new contents in 215, and B may comprise a DOM node currently on the screen (that is, in DOM Tree 217); 2) Determining a sequence of DOM manipulation operations, selected from a set that includes at least creating a new DOM node, inserting a DOM node into the DOM tree 217 at a particular position, removing a particular DOM node from the DOM tree 217, and changing the position of an existing DOM node in 217, such that when the sequence of operations is applied to the DOM tree 217, the end state of 217 will be that it reflects the newly rendered state requested in 215, and that additionally, at the position where each node ‘A’ (from the pairs in step #1) appears in the target state from 215, the DOM node at that position is actually ‘B’ (the previously existing node in 217 before the update)—that is, B is reused in place of the new A.

Options for constructing preservation pairs for a patch algorithm, for one or more embodiment, may comprise: 1) Identify a preservation pair (A,B) when A,B have the same value for the HTML “id” attribute or other unique attribute. 2) Identify a preservation pair (A,B) when A,B have the same value for the HTML “name” attribute or other locally unique attribute, and are contained within respective parent nodes that have the same value for the HTML “id” attribute or other unique attribute. 3) Identify a preservation pair (A,B) when A is the only element/node in a region of the new rendering that matches a CSS selector S, and B is the only such element that matches S in the template's previous rendering in 217. 4) Accept a CSS selector S and a user-defined function F, such that S matches potentially multiple nodes in both the new rendering and the previous rendering, and F is a function that takes a DOM node and returns a string. Apply the function F to each node/element that matches in either the old or new rendering, and identify a preservation pair wherever the function returns the same string for both and old node and a new node.

FIG. 3 is an illustration depicting an example online application template in accordance with an embodiment. In an embodiment, a nested tree structure may be utilized, as shown in FIG. 3. For the example depicted in FIG. 3, part 301 may comprise a whole template. Part 301 may comprise parts 302 and 305, for example. Parts 302 and 305 may be nested within part 301, in an embodiment. Similarly, parts 303 and 304 may be nested within part 302. By structuring template 301 in a nested tree structure, data changes to part 303, for example, may result in a re-rendering of part 303 without affecting part 304 or part 305. Of course, the structure depicted in FIG. 3 is merely an example structure, and claimed subject matter is not limited in scope in these respects.

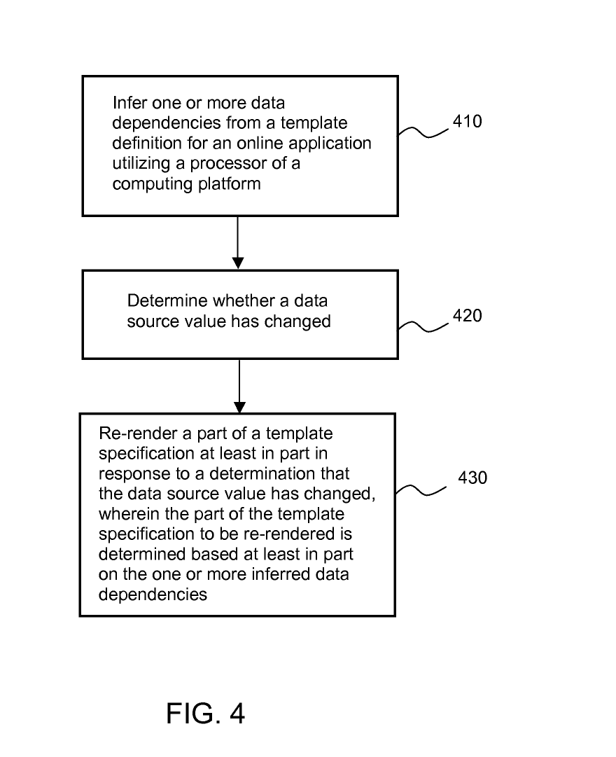

FIG. 4 is a flow diagram illustrating an example process for generating and/or updating a web page for an online application in accordance with an embodiment. At block 410, one or more data dependencies may be inferred from a template definition for an online application utilizing a processor of a computing platform. A determination may be made at block 420 as to whether a data source value has changed. At block 430, a part of a template specification may be re-rendered at least in part in response to a determination that the data source value has changed. In an embodiment, the part of the template specification to be re-rendered may be determined based at least in part on the one or more inferred data dependencies, for example.

Claimed subject matter may include all of, less than, or more than blocks 410-430. Further, the order of blocks 410-430 depicted in FIG. 4 is merely an example order, and claimed subject matter is not limited in scope in these respects.

As mentioned previously, embodiments in accordance with claimed subject matter may infer data dependencies from a template definition and/or specification. Data dependencies may be inferred at run-time at least in part by rendering a template and determining which data sources the template utilizes. It should be noted that the online application developer's code does not need to be modified to accomplish this data source tracking. This stands in sharp contrast to prior systems that may require that data dependencies between templates and data sources be explicitly declared or that helper code be developed to supply a wrapped dynamic value object with which a templating system may register to receive updates to changing data sources. Typically, for prior online application systems, an application developer may write custom code to listen for data change events and to locate a template on a screen and perform updates to the template in response to a detection of a data change event.

Embodiments in accordance with claimed subject matter may provide advantages over prior systems in that live-updating web pages are no more difficult to develop than non-live updating web pages. In an embodiment, a live-updating system may be completely or substantially transparent to the developer. Also, embodiments in accordance with claimed subject matter may not require developers to add explicit subscription or dependency information alongside a template, or to require writing patch procedures that explain how to manually update a template in place in response to an update arriving. Embodiments in accordance with claimed subject matter may reduce time to market, may reduce code size, may provide greater ease of maintenance, and may reduce bugs that may otherwise result from explicitly declaring data dependencies between templates and data sources for prior systems.

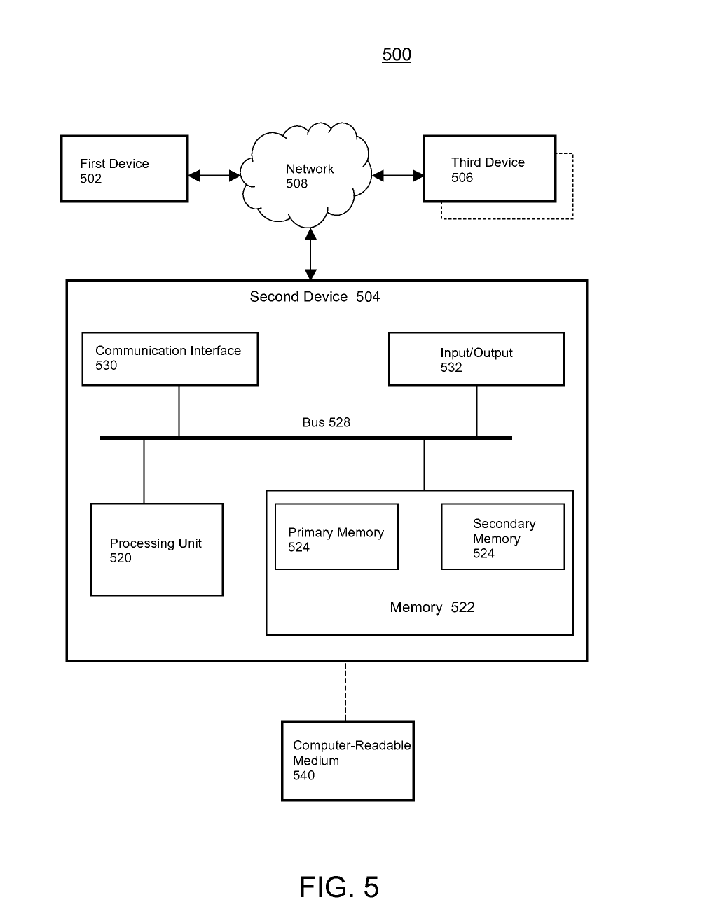

FIG. 5 is a schematic diagram illustrating an exemplary embodiment 500 of a computing environment system that may include one or more devices configurable to implement techniques and/or processes described above in connection with online application live-update web pages discussed above in connection with FIGS. 1-4, for example. System 500 may include, for example, a first device 502, a second device 504, and a third device 506, which may be operatively coupled together through a network 508.

First device 502, second device 504 and third device 506, as shown in FIG. 5, may be representative of any device, appliance or machine that may be configurable to exchange data over network 508. By way of example but not limitation, any of first device 502, second device 504, or third device 506 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between at least two of first device 502, second device 504, and third device 506. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 506, there may be additional like devices operatively coupled to network 508.

It is recognized that all or part of the various devices and networks shown in system 500, and the processes and methods as further described herein, may be implemented using or otherwise include hardware, firmware, software, or any combination thereof (other than software per se).

Thus, by way of example but not limitation, second device 504 may include at least one processing unit 520 that is operatively coupled to a memory 522 through a bus 528.

Processing unit 520 may be representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 may be representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 540. Computer-readable medium 540 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 532 may include an operatively configured display, speaker, keyboard, mouse, trackball, touch screen, data port, etc.

The term “computing platform” as used herein refers to a system and/or a device that includes the ability to process and/or store data in the form of signals or states. Thus, a computing platform, in this context, may comprise hardware, software, firmware or any combination thereof (other than software per se). Computing platform 500, as depicted in FIG. 5, is merely one such example, and the scope of claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, mobile audio or video playback or recording devices, or any combination of the above. Further, unless specifically stated otherwise, a process as described herein, with reference to flow diagrams or otherwise, may also be executed and/or controlled, in whole or in part, by a computing platform.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Methodologies described herein may be implemented by various techniques depending, at least in part, on applications according to particular features or examples. For example, methodologies may be implemented in hardware, firmware, or combinations thereof, along with software (other than software per se). In a hardware embodiment, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter.

Some portions of the preceding detailed description have been presented in terms of logic, algorithms and/or symbolic representations of operations on binary states stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally is, considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, or the like may refer to actions and/or processes of a specific apparatus, such as a special purpose computer or a similar special purpose electronic computing device. In the context of this specification, therefore, a special purpose computer and/or a similar special purpose electronic computing device is capable of manipulating and/or transforming signals, typically represented as physical electronic and/or magnetic quantities within memories, registers, and/or other information storage devices, transmission devices, or display devices of the special purpose computer and/or similar special purpose electronic computing device. In the context of this particular patent application, the term “specific apparatus” may include a general purpose computer once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change and/or transformation in magnetic orientation or a physical change and/or transformation in molecular structure, such as from crystalline to amorphous or vice-versa. In still other memory devices, a change in physical state may involve quantum mechanical phenomena, such as, superposition, entanglement, or the like, which may involve quantum bits (qubits), for example. The foregoing is not intended to be an exhaustive list of all examples in which a change in state from a binary one to a binary zero or vice-versa in a memory device may comprise a transformation, such as a physical transformation. Rather, the foregoing are intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has been illustrated and/or described what are presently considered to be example features, it will be understood by those skilled in the art that various other modifications may be made, and/or equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and/or equivalents thereof.

1. A method, comprising:
inferring one or more data dependencies from a template definition for an online application utilizing a processor of a computing platform;
determining whether a data source value has changed; and
re-rendering a part of a template specification at least in part in response to a determination that the data source value has changed, wherein the part of the template specification to be re-rendered is determined based at least in part on the one or more inferred data dependencies.

2. The method of claim 1, wherein the inferring the one or more data dependencies comprises inferring the one or more data dependencies at run-time.

3. The method of claim 1, wherein the inferring the one or more data dependencies comprises rendering a template specification to determine one or more data sources.

4. The method of claim 3, wherein the rendering the template comprises rendering the template within a browser executed on an end-user computing platform.

5. The method of claim 1, wherein the inferring the one or more data dependencies comprises generating a dependency context object.

6. The method of claim 5, wherein the determining whether a data source value has changed comprises receiving an indication from a reactive data source that its value has changed.

7. The method of claim 6, wherein the re-rendering the part of the template specification further comprises providing updated instructions to a browser application executed on the computing platform.

8. An apparatus, comprising:
a processor to infer one or more data dependencies from a template definition for an online application, the processor further to determine whether a data source value has changed, the processor further to re-render a part of a template specification at least in part in response to a determination that the data source value has changed, wherein the part of the template specification to be re-rendered is determined based at least in part on the one or more inferred data dependencies.

9. The apparatus of claim 8, the processor to infer the one or more data dependencies at least in part by inferring the one or more data dependencies at run-time.

10. The apparatus of claim 8, the processor to infer the one or more data dependencies at least in part by rendering a template specification to determine one or more data sources.

11. The apparatus of claim 10, the processor to render the template at least in part by rendering the template within a browser application.

12. The apparatus of claim 8, the processor to infer the one or more data dependencies at least in part by generating a dependency context object.

13. The apparatus of claim 12, the processor to determine whether a data source value has changed at least in part by receiving an indication from a reactive data source that its value has changed.

14. The apparatus of claim 13, the processor to re-render the part of the template specification at least in part by providing updated instructions to a browser application.

15. An article, comprising: a storage medium having stored thereon instructions executable by a processor of a computing platform to:
infer one or more data dependencies from a template definition for an online application;
determine whether a data source value has changed; and
re-render a part of a template specification at least in part in response to a determination that the data source value has changed, wherein the part of the template specification to be re-rendered is determined based at least in part on the one or more inferred data dependencies.

16. The article of claim 15, wherein the storage medium has stored thereon further instructions executable by the processor of the computing platform to infer the one or more data dependencies at least in part by inferring the one or more data dependencies at run-time.

17. The article of claim 15, wherein the storage medium has stored thereon further instructions executable by the processor of the computing platform to infer the one or more data dependencies at least in part by rendering a template specification to determine one or more data sources.

18. The article of claim 17, wherein the storage medium has stored thereon further instructions executable by the processor of the computing platform to render the template at least in part by rendering the template within a browser application.

19. The article of claim 15, wherein the storage medium has stored thereon further instructions executable by the processor of the computing platform to infer the one or more data dependencies at least in part by generating a dependency context object.

20. The article of claim 15, wherein the storage medium has stored thereon further instructions executable by the processor of the computing platform to re-render the part of the template specification at least in part by providing updated instructions to a browser application.
